(19) United States
(12) Patent Application Publication
(10) Pub. No.: US 2010/0174596 A1
(43) Pub. Date: Jul. 8, 2010

(54) METHOD AND APPARATUS FOR MOBILE OFFER FULFILLMENT

(76) Inventors: Andrea Gilman, Chappaqua, NY (US); Daniel Poswolsky, Plainview, NY (US); James J. Anderson, Mount Vernon, NY (US)

Correspondence Address: BUCKLEY, MASCHOFF & TALWALKAR LLC, 50 LOCUST AVENUE, NEW CANAAN, CT, 06840, US

(21) Appl. No.: 12/727,512

(22) Filed: Mar. 19, 2010

Related U.S. Application Data
(63) Continuation-in-part of application No. 11/923,306, filed on Oct. 24, 2007.
(60) Provisional application No. 61/161,577, filed on Mar. 19, 2009.

(51) Int. Cl. G06Q 30/00; G06F 15/16

(52) U.S. Cl. 705/14.23; 705/14.36; 709/206

(57) ABSTRACT

Rewards systems, methods, means and computer program code are provided which include a transaction processing system, receiving a transaction authorization request message generated from a point of interaction, the transaction authorization request message including a purchase amount, and a customer account identifier, the transaction processing system generating an authorization response message for transmission to the point of interaction. The rewards systems further include a messaging system, in communication with the transaction processing system, generating a rewards message for transmission to a mobile device associated with the customer account identifier, the rewards message including details of a status associated with a reward transaction.

### CROSS-REFERENCE TO RELATED APPLICATION

This application claims the benefit of and priority to U.S. Provisional Patent Application Ser. No. 61/161,577, filed Mar. 19, 2009, and is a continuation in part of U.S. patent application Ser. No. 11/923,306 the contents of each of which are hereby incorporated by reference herein in their entirety for all purposes.

### BACKGROUND

Embodiments disclosed herein relate to payment systems. In particular, some embodiments relate to methods, apparatus, systems, means and computer program products for processing and fulfilling mobile offers.

Payment card loyalty programs have been in wide spread use for some time. Most customers who hold payment cards participate in some form of loyalty program, including merchant-specific frequent buyer programs, airline mileage programs, or the like. In general, these programs are successful, as many customers who participate in loyalty programs indicate that their participation in the programs has an impact on their purchasing decisions.

Unfortunately, the ubiquity of these programs has led to dilution of their impact. With so many programs, and so little differentiation, customer's behaviors are not directly driven by the programs. As a result, many customers do not actively participate in many loyalty programs even after they have enrolled.

The reward delivery mechanism for most loyalty programs has primarily been the use of store coupons, statement inserts or other printed coupons that require a customer to redeem the coupon in a future purchase. Currently, it is estimated that the percentage of reward coupons that are redeemed by customers is less than 1% of the total coupons distributed. As card based reward programs and benefits become more widespread, financial institutions and other entities are searching for more cost effective ways to deliver value to their cardholders.

Further, many merchants simply do not have the expertise or ability to effectively use their customer data to develop and administer reward programs. It would be desirable to reduce the barriers to customers to make it easier for them to participate in reward programs and to receive awards. It would further be desirable to provide systems and methods that allow the communication and fulfillment of reward offers using mobile devices such as mobile telephones or the like.

Some embodiments of U.S. patent application Ser. No. 11/923,306, incorporated herein by reference, provide reward messaging to consumers at the point of interaction by displaying reward messaging on the point of sale or other point of interaction device. In some situations, however, it is desirable to provide messaging at the point of interaction without modifying existing point of sale devices.

### BRIEF DESCRIPTION OF THE DRAWINGS

Features and advantages of some embodiments of the present invention, and the manner in which the same are accomplished, will become more readily apparent upon consideration of the following detail description of the invention taken in conjunction with the accompanying drawings, which illustrate preferred and exemplary embodiments and which are not necessarily drawn to scale, wherein:

FIG. 1 is a block diagram illustrating a transaction process according to some embodiments of the present invention.

FIG. 2 is a diagram illustrating an offer and eligibility data entry process according to some embodiments of the present invention.

FIGS. 3A and 3B are diagrams illustrating user interfaces presented during a registration process according to some embodiments of the present invention.

FIGS. 4A and 4B are diagrams illustrating user interfaces presented during an offer selection process according to some embodiments of the present invention.

FIG. 5 is a diagram illustrating an offer selection process according to some embodiments of the present invention.

FIG. 6 is a diagram illustrating a transaction process according to some embodiments of the present invention.

FIG. 7 is a diagram illustrating an overall cardholder transaction experience according to some embodiments of the present invention.

FIG. 8 is a diagram illustrating a rewards system server according to some embodiments of the present invention.

FIG. 9. is a diagram illustrating an offer database pursuant to some embodiments of the present invention.

FIG. 10 is a diagram illustrating a cardholder database pursuant to some embodiments of the present invention.

FIG. 11 is a diagram illustrating a user interfaces presented after a reward qualifying transaction according to some embodiments of the present invention.

### DETAILED DESCRIPTION

Applicants have recognized that there is a need for methods, systems, apparatus, means and computer program products for processing rewards transactions. More particularly, there is a need for mobile offer fulfillment and communication which allow cardholders to select offers using their mobile device as well as to receive notifications of reward progress or qualification on their mobile devices. Cardholders may, in some embodiments, be notified of reward progress or qualification substantially at the same time as having completed a qualifying transaction at a point of sale.

In general, embodiments of the present invention allow consumers (otherwise referred to herein as “payment device holders” or “cardholders” to refer to participants who earn rewards pursuant to the present invention) a way to receive a message (such as an SMS message) on their mobile device as soon as they become eligible for rewards based on a transaction. For example, an SMS message may be sent to a cardholder's mobile telephone while the cardholder is still at a merchant POS location if a transaction conducted at the POS location made the cardholder eligible to receive an award (e.g., such as a statement credit, or bonus points at the POS, etc.). Cardholders may also receive messages (such as SMS messages) to update them on their status in promotions. For example, if a cardholder is a participant in a promotion such as a “spend $x at merchant y” or “shop x more times at merchant y to get a reward”, the cardholder may receive a status message as soon as the cardholder completes a qualifying transaction. Embodiments enable “paperless” fulfillment of targeted reward offers without requiring a cardholder to have a coupon or promotional code. Embodiments provide prompt and clear communication of status and earnings to participating cardholders.

Pursuant to some embodiments, rewards may include statement credits as well as bonus points earned through purchases made at participating retail locations. Cardholders will earn rewards by meeting established criteria ranging from a set number of shopping instances to specific individual purchase amounts on given transactions. Here are several illustrative examples of ways that cardholders can earn rewards pursuant to some embodiments:
Reaching a cumulative dollar-spend threshold at a merchant, group of merchants, merchant classification code (“MCC”), or range of MCCs over a predetermined number of days.
Making more than a predetermined number of transactions at a merchant, group of merchants, MCC, or range of MCCs over a predetermined number of days.

Those skilled in the art will appreciate that other reward program structures may also be used in conjunction with embodiments of the present invention.

As used herein, the term “offer” is used to refer to a discount, rebate or other promotional feature provided to a consumer. “Offers” may be selected and presented to consumers in a number of different ways. For example, in some embodiments, a location-adjusted propensity score may be used to present offers to consumers based on a scoring system associated with the consumer's shopping history and current location. Such techniques are described in U.S. patent application Ser. No. 12/727,333, filed on even date herewith (Attorney Docket Number M01.161, titled “SYSTEMS AND METHODS TO PROVIDE OFFERS TO MOBILE DEVICES IN ACCORDANCE WITH PROXIMITY-SENSITIVITY SCORES”) which is owned by the assignee of the present application and the contents of which are hereby incorporated by reference in their entirety for all purposes.

In some embodiments, offers may be selected and presented to consumers by analyzing and segregating payment card account profiles into clusters and targeting offers to cardholders. Offers may be targeted based on analyzing customer transactions with merchants from a merchant category as compared with transactions with merchants from a universe of merchants. Customers who have no transaction history with a merchant may be selected for offers based on similarities with respect to other customers of the merchant. Such targeting techniques are described in PCT Application No. PCT/US2007/086114, filed on Nov. 30, 2007, the contents of which are hereby incorporated by reference in their entirety for all purposes.

As used herein, features of embodiments will be described in conjunction with “payment devices”. A payment device may include (but is not limited to), for example, credit cards, debit cards, stored value cards, or other payment devices associated with payment accounts. In some embodiments, features may be used in conjunction with “loyalty cards” or devices used to identify a member's participation in a loyalty program. A payment device or loyalty card may be embodied in various forms, including, for example, as a magnetic stripe card, a radio frequency identification (“RFID”) card or other “contactless” card, smart card, or the like. Further, embodiments may also be used in conjunction with virtual cards (e.g., where no physical card is used for a transaction), or other payment devices (such as, for example, contactless key fobs, payment-enabled mobile devices or telephones, or the like). Further, although features will be described in an illustrative example with transactions conducted in the U.S., embodiments may be used in any region or cross-regions.

As used herein, the terms “POS” or “POS terminal” are used to refer to devices provided at a “point of interaction” with a customer to enable the customer to make a purchase or conduct a transaction. For example, a POS device may be a POS terminal located at a physical point of sale location (such as a brick and mortar merchant retail location), or a virtual POS device (such as a “shopping cart” used by an Internet retailer to facilitate a payment transaction over the Internet), or a virtual terminal used by a mail order or telephone retailer to facilitate transactions over the telephone or by mail. In general, as used herein, the term POS or POS terminal refers to any device or set of devices that are provided at a point of interaction with a customer during a purchase or sale transaction.

As used herein, the term “mobile device” refers to handheld or mobile devices carried by cardholders. For example, a mobile device may be a handheld cellular telephone or personal digital assistant. In some embodiments, mobile devices are capable of receiving data or text messages (e.g., such as SMS messages or email messages). In some embodiments, mobile devices are provided with the ability to browse and interact with Websites, allowing cardholders to select offers and interact with certain aspects of the rewards system of the present invention. In some embodiments, the mobile devices are provided with (or updated to have) an application program which allows communication with the rewards system of the present invention. For example, a mobile device with an application pursuant to the present invention may receive rewards messages and other information about offers and participation via XML or other messaging techniques.

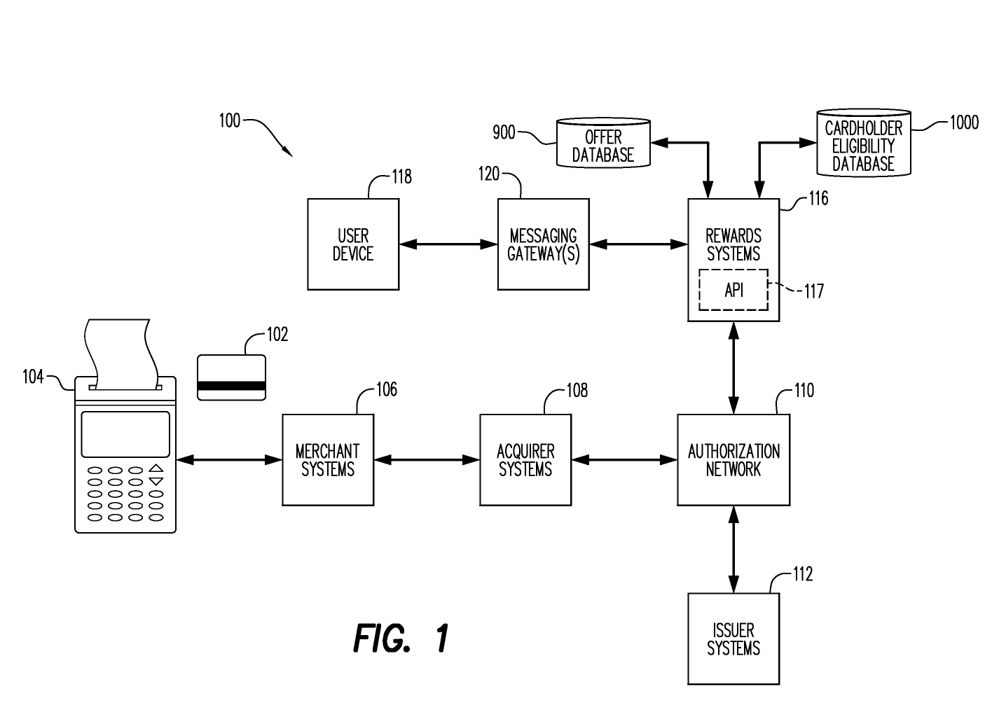

Features of some embodiments will now be described by reference to FIG. 1, in which a block diagram representation of a reward processing transaction 100 is shown. Reward processing transaction 100 is performed using a number of devices or entities interacting over one or more networks to facilitate a payment transaction involving a payment device account accessed by payment devices 102. For example, as depicted, reward processing transaction 100 involves interaction between a variety of devices or entities, including point of sale devices 104, merchant systems 106, acquirer systems 108, authorization networks 110, issuer systems 112, a reward data source 114, reward systems 116 (storing or having access to data from an offer database 900 and a cardholder database 1000), a messaging gateway 120, and user devices 118 held by (or associated with) the cardholder (who owns or controls the payment device 102).

In some embodiments, user devices 118 are mobile devices carried by the cardholder and which have an application or code which allows the mobile device 118 to receive reward messaging or information pursuant to the present invention. For example, user devices 118 may include mobile phones which are capable of browsing the Internet (e.g., to clip or select offers, or to view rewards status information as discussed further below). The mobile phones may also be capable of receiving short text messages (e.g., such as SMS messages) with information regarding reward eligibility, status or participation. User devices 118 may also include personal computers or other devices which may be operated by participants to update, view or otherwise interact with the rewards system of the present invention. A participant may use several different user devices 118 to interact with the system of the present invention. However, in some embodiments, in order for a participant to receive reward messaging at the point of transaction, at least one of the user devices 118 should be a mobile device carried by the participant.

Those skilled in the art will recognize that a large number of devices and entities may be involved in a payment system pursuant to the present invention. For example, authorization networks 110 may process transactions from a number of different point of sale devices 104, a number of different merchant systems 106, a number of different acquirer systems 108, and a number of different issuer systems 112. For ease of exposition, only a single one of each of these devices, systems or entities is shown in the block diagram of FIG. 1.

Point of sale device 104 (also referred to herein as a “POS” device or location) may be any of a number of types of devices, and may also refer to a “point of interaction” such as Internet commerce sites that receive payment account numbers from customers who shop online, mail order or telephone (MOTO) merchants who receive payment account numbers by telephone and/or mail, and physical point of sale terminals located in brick-and-mortar retail stores. In the case of physical point of sale terminals, a payment device 102 (e.g., a credit or debit card) is presented to the terminal by a customer and read by the terminal to input the number of the payment device account to which a purchase transaction is to be charged. In the case of other types of POS locations, the payment device account number is input into the POS location by human data entry or the like. Those skilled in the art will appreciate that a physical embodiment of a payment device is not needed—for example, a “virtual” payment device may be used where the cardholder simply enters (or causes to be entered) a payment device account number.

POS device 104 may be connected to a merchant system 106. A number of different POS devices may be connected to a merchant system. Each merchant system 104 is a computer or computer system that receives transaction data from the POS devices 104 connected to it and that forwards authorization requests and requests to settle purchase transactions to an acquirer 108. In the case of an Internet shopping site, the POS device(s) and the merchant processing system may be integrated together into a single computer system. In some cases (not illustrated), POS device 104 may communicate directly with acquirer systems 106, without an intervening merchant processing system. The term “acquirer” is widely used in the payment processing field, and refers to financial institutions such as banks or other financial systems that have agreements with merchants to receive and forward purchase transaction authorizations and settlement requests on behalf of the merchants. The term “acquirer” also refers to processing agents that act on behalf of such financial institutions or systems. Each acquirer typically serves numerous merchants, and accordingly each acquirer system 108 may be in communication with numerous merchant systems 106.

In some embodiments, one or more merchant systems 106 may directly connect or communicate with authorization systems 110 (e.g., a merchant system may have the capability of transmitting and receiving authorization messages without need for communication with a separate acquirer system 108).

The term “issuer” is widely used in the payment processing field, and refers to financial institutions such as banks or other financial systems that issue payment products (such as payment device, debit card or credit card accounts, etc.) to customers or other account holders. The term “issuer” also refers to processing agents that act on behalf of such financial institutions or systems. Each issuer typically serves a number of account holders. Authorization systems 110 may be in communication with a number of different issuer systems 112.

Authorization systems 110 act to authorize transactions initiated at POS locations 104 involving payment devices associated with the authorization network. In one illustrative example, authorization systems 110 include the BankNet® network operated by MasterCard Worldwide®, which serves to facilitate authorizations of payment transactions involving MasterCard branded payment devices. Those skilled in the art will recognize that other authorization networks are also known and used for processing payment transactions (e.g., such as the payment card authorization networks operated by Visa International Service Association® or American Express®). Authorization systems 110 receive payment authorization request messages from acquirer systems 108, and processes the authorization request messages to authorize or decline a payment transaction. In some embodiments, authorization request messages may be routed to issuer systems 112 for authorization processing. Those skilled in the art will also appreciate that authorization systems 110 may also include a transaction clearing and settlement function; however, for the purpose of this disclosure, the systems 110 will simply be referred to as the authorization systems.

Embodiments as illustrated in FIG. 1 also involve one or more reward system(s) 116 containing rewards-related data stores (including, for example, offer database 900 and cardholder eligibility database 1000) and in communication with authorization systems 110 and. Pursuant to the embodiment of FIG. 1, the reward system 116 stores or accesses data identifying payment device accounts participating in one or more reward programs associated with authorization systems 110, as well as details about those reward programs. In some embodiments, some of the data stored at (or accessible to) the rewards system 116 is or includes an extract of data received from sources such as, for example, the authorization network 110 and issuer systems 112 and that is generated, for example, on a batch basis (e.g., daily or on some other schedule).

In some embodiments, each reward program administered using features of the invention may include data identifying the types of transactions that qualify for a reward, as well as other eligibility criteria (such as program eligibility dates, etc.). In some embodiments, payment device accounts may qualify based on account ranges (e.g., an issuer may specify that accounts in a certain account number range are eligible for participation in a reward program), or based on individual accounts. In some embodiments, individual accounts (or account ranges) may have different levels of rebate or reward program eligibility. Pursuant to some embodiments, eligibility may be determined using statistical analysis based on prior transaction information associated with individual accounts. In some embodiments, the eligibility may be determined based on spend triggers or amounts at a participating merchant which causes the customer to become eligible for a discount at a second merchant. Further, in some embodiments, eligibility may be determined based on transactions conducted during a specific period of time (e.g., a customer who has not used their account for a while may be given a specific period of eligibility to receive a reward to encourage the customer to use their account). Other targeting techniques may be based on a location propensity scoring system, such as the one described in U.S. patent application Ser. No. 12/727,333, filed on even date herewith (Attorney Docket Number M01.161) which is owned by the assignee of the present application and the contents of which are hereby incorporated by reference in their entirety for all purposes. Other eligibility criteria will become apparent to those skilled in the art upon reading this disclosure. Cardholder eligibility database 1000 or offer database 900 are used to store the data (or a subset of the data) needed to perform such a lookup under rewards system 116, either on an individual account or an account range basis.

The data stored in (or accessible to) rewards system 116 may include participation criteria including, for example: account numbers or account number ranges, acquirer and or merchant identifiers, information identifying qualifying purchase transactions and thresholds, reward information (a fixed amount, a percentage of a transaction amount, etc.), and current status information (e.g., including each cardholder's current reward balance). The rewards systems 116 may also store one or more phone numbers for cardholders who are participants in the rewards program of the present invention. The registration of these phone numbers will be discussed further below. In general, the phone numbers are used to deliver rewards messaging data to cardholders based on information received in an authorization message. Rewards system 116 further stores (e.g., at database 900 or 1000 or the like) rewards messaging data for delivery to user devices 118 associated with participating cardholders.

Rewards System 116 could also include a front-end offer display mechanism (e.g., a mobile WAP site or a downloadable application) for cardholders to learn about what offers are available and register to participate in specific offers (e.g., User Interface 400).

One or more APIs 117 are provided to allow interaction between devices and the data associated with the rewards system 116. For example, in some embodiments, the offer data may be accessed using an API which provides an interface to the front-end offer display mechanism (e.g., a mobile WAP site or a downloadable application) and Messaging Gateway(s) 120. In one current embodiment, the API is a RESTful web service interface that allows offer data to be retrieved using XML, including targeted and non targeted offers and location based offers. The offer data retrieved via the API may include offer terms and conditions and other details that may be, for example, presented to a consumer for their selection or opt in to participate. In some embodiments, multiple APIs 117 may be provided, allowing access or interaction with one or more data sources associated with the rewards systems 116. In some embodiments, a secure API may also be provided to allow cardholders to access reward status via their mobile device.

In the embodiment depicted in FIG. 1 the rewards system 116 is shown as a separate system or data source. In some embodiments, the rewards system may be a database in communication with the authorization system 110 and storing data identifying rewards programs, reward details, qualifying information and phone numbers associated with registered cardholders who wish to receive notifications on their mobile devices. Further, while rewards-related databases (900 and 1000) are shown in FIG. 1 separate from rewards system 116, the rewards-related databases may be a data extract to/from rewards system 116 or a linked database pulling segments of data to/from rewards system 116. Other data implementations may also be used so long as the authorization system 110 has access to current rewards program data, reward details, qualifying information, and contact information.

Transactions which are identified as being associated with a reward offer may result in the generation of one or more messages transmitted to the cardholder via a messaging gateway 120. The messaging gateway 120, for example, may be an SMS gateway which allows the transmission of SMS messages to mobile devices. Pursuant to some embodiments, the messaging text and phone number to be messaged are identified by the reward system 116 in response to reward transaction processing as described herein. A number of different types of messages may be generated and transmitted. For example, in some embodiments, cardholders may receive SMS messages shortly after they complete a reward-qualifying transaction at a point of sale device. The message may update the cardholder of their status in a particular promotion (e.g., such as “Congratulations John—Your purchase qualifies you for a $10 discount the next time you shop at Merchant Name!”). Messages may also congratulate a cardholder on purchases that earn them a reward (e.g., “Congratulations John—You just earned a $10 credit. Your credit will show up on your next billing statement.”). A variety of other messages may be provided to offer real-time discounts and rewards while a consumer is at a point of sale and to reinforce a cardholder's participation and progress in reward programs.

A number of different messaging gateways 120 may be used to transmit messages pursuant to embodiments of the present invention. In some embodiments, gateways 120 may be operated or controlled by mobile operators or networks. In some embodiments, gateways 120 may further be capable of transmitting messages using other messaging protocols (e.g., such as electronic mail, Internet Messaging protocols, XML, or the like). For example, a cardholder may specify one or more desired messaging formats in which to receive their communications regarding rewards. In some embodiments, the messaging formats are preferably formats which allow near-instant communication with a cardholder (e.g., to alert the cardholder about rewards status substantially in real-time or shortly after a purchase is made at a point of sale location).

To illustrate features of some embodiments a typical transaction process will now be described by reference to FIG. 1. The transaction assumes that the cardholder carrying payment device 102 also carries a user device 118, and that the cardholder has registered to participate in the rewards program administered by the rewards system 116 (e.g., the cardholder has provided his or her mobile device number and has given his or her consent to receive mobile messages from the rewards system). In some embodiments, cardholder's may be auto-enrolled by their payment card issuer (e.g., a range or selection of account numbers may be enrolled by a card issuer).

The processing begins where the cardholder makes a purchase at a merchant location. The cardholder presents (physically or electronically) his or her payment device 102 at a POS location 104. The POS device causes an authorization request to be transmitted to an authorization network 110 (e.g., through merchant and acquirer systems). The authorization network 110 obtains an authorization response for the transaction (e.g., by stand in processing or by consulting with an issuer 112). In the event the transaction is authorized, a message may be transmitted to rewards system 116 so that a determination may be made whether the cardholder and the transaction are eligible for a reward or other offer. The cardholder's eligibility may be determined, for example, based on a number of variables such as: (1) the cardholder's primary account number or “PAN”, (2) data in the payment transaction authorization request such as the payment amount, (3) the identity of the merchant, and/or (4) the date/time of the transaction.

If the cardholder/transaction is eligible for a reward or offer (or the transaction brings the cardholder closer to earning a reward), the rewards system 116 may cause a message to be transmitted to the user device 118 (through a messaging gateway 120) informing the cardholder of the reward or status. Pursuant to some embodiments, the message transmitted to the user device 118 may be delivered substantially at the same time as an authorization response message is delivered to the POS device 104. That is, the cardholder may be notified of the earning of an offer (or progress toward earning a reward) substantially at the same time as completing the transaction at the POS device. In some embodiments where such substantially in real time communication are not possible, the messaging may be generated at a later time (e.g., in conjunction with transaction clearing processing).

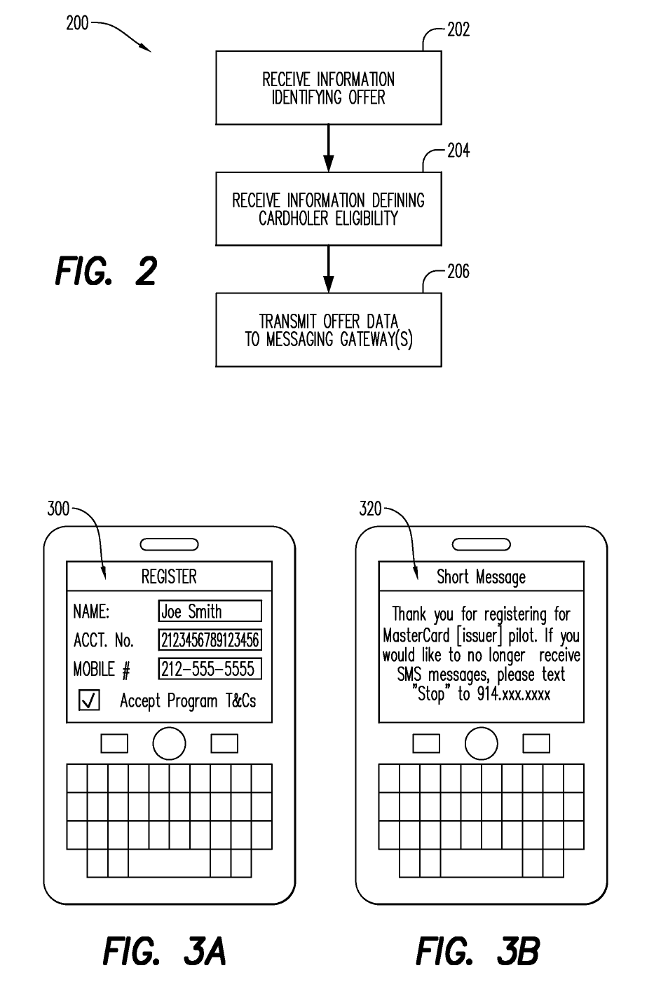

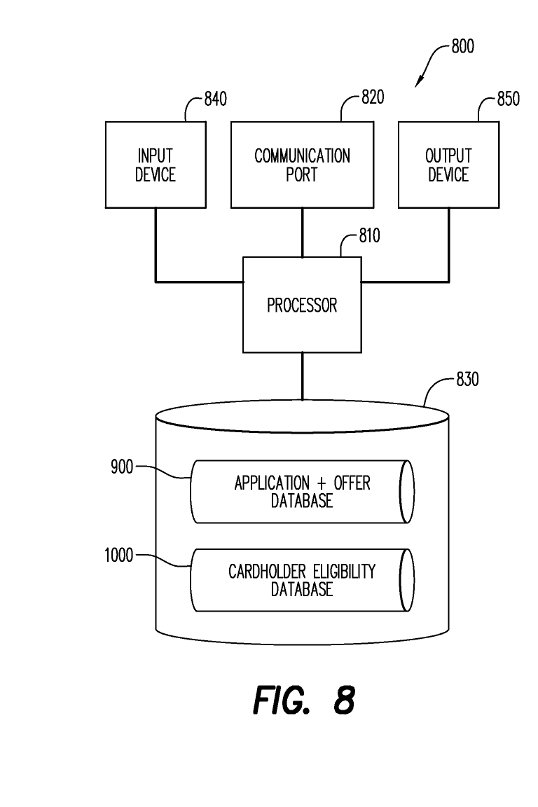

Reference is now made to FIG. 2, where a flow diagram is shown that depicts an offer and eligibility process 200 that may be performed by rewards system 116 of FIG. 1. Various elements of diagram 100 and/or computing system 800 (described below in conjunction with FIG. 8) may execute process 200 according to some embodiments. The flow diagram of process 200 does not necessarily imply a fixed order to the actions, and embodiments may be performed in any order that is practicable.

Process 200 and all other processes mentioned herein may be embodied in processor-executable instructions read from one or more computer-readable media, such as a floppy disk, a CD-ROM, a DVD-ROM, and a magnetic tape, and then stored in a compressed, uncompiled and/or encrypted format. In some embodiments, hard-wired circuitry may be used in place of, or in combination with, instructions for implementation of processes according to some embodiments. Embodiments are therefore not limited to any specific combination of hardware and software.

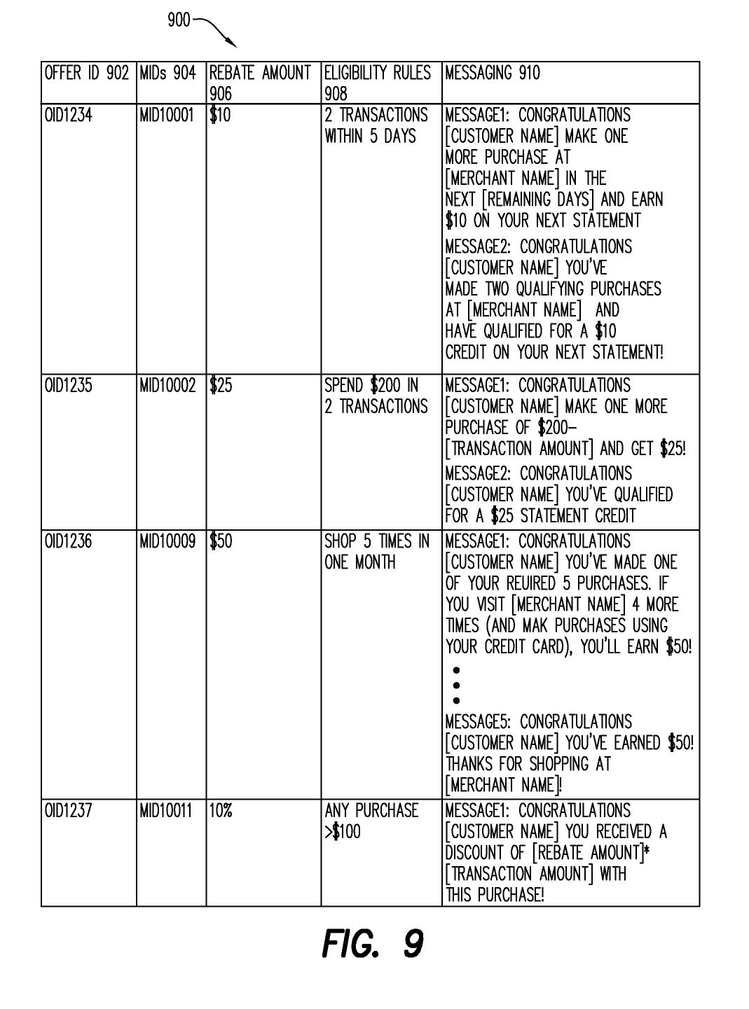

Process 200 begins at 202 where information identifying an offer is received. For example, the offer information may be received from a merchant (or an agent associated with a merchant) that wishes to offer rewards in conjunction with the rewards system of the present invention. The information identifying an offer, in some embodiments, includes a number of variables for each offer, including: (i) any application merchant identifiers (e.g., such as “MIDs” described below in conjunction with FIG. 9), (ii) a rebate amount for each offer, (iii) offer eligibility or qualification rules and criteria (such as a spend threshold and/or a transaction threshold), and (iv) messaging rules (e.g., such as rules that specify when specific messages should be transmitted to participating cardholders). The information received at 202 may be stored at a database such as the offer database 900 (described below in conjunction with FIG. 9). Pursuant to some embodiments, the data received at 202 may be entered or updated on a regular basis or as offers change, are created, or are otherwise modified.

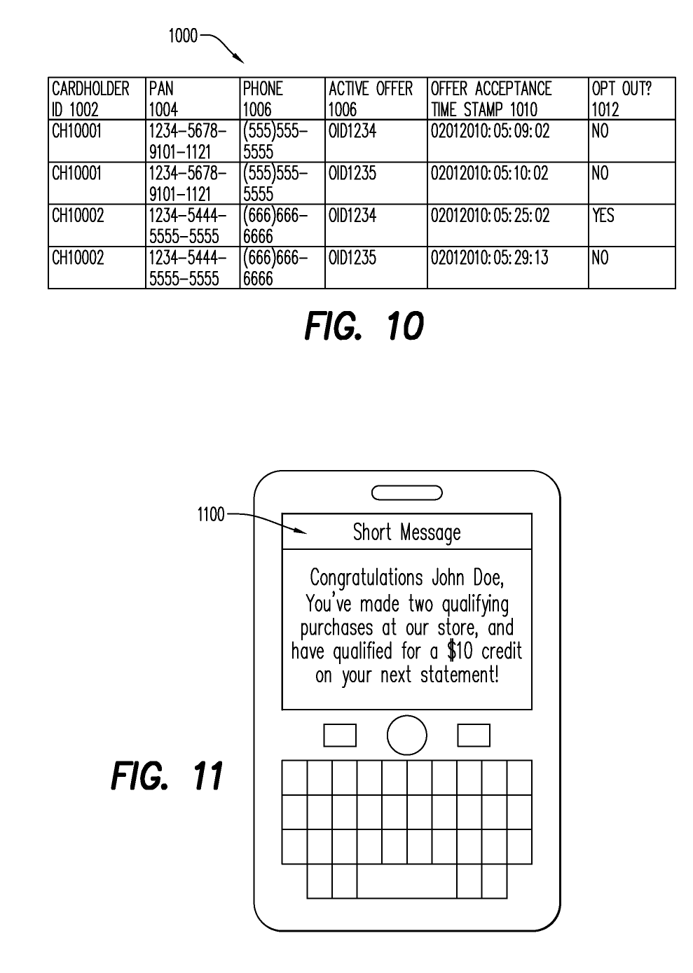

Processing continues at 204 where information defining cardholder eligibility is received. The information defining cardholder eligibility may be specified by the merchant sponsor of a particular offer, by an issuer, or by a combination of parties. The data received at 204 may be stored at a database such as the cardholder database 1000 (described below in conjunction with FIG. 10). The data may be provided in real time or in a batch process. The data received at 204 may include information identifying the cardholders who have opted to participate in a particular offer, and may include a number of variables, including: (i) the cardholder's primary account number (or “PAN”) of the payment instrument that will be used to conduct transactions to earn a particular offer, (ii) a phone number associated with the cardholder and to which offer messages are to be delivered, (iii) information identifying one or more active offers that the cardholder has elected to participate in. In some embodiments, a unique cardholder identification number may also be used, allowing each cardholder to enroll one or more payment devices in one or more offers. In some embodiments, processing at 204 continues on an iterative basis as cardholders enroll and opt in to participate in different offers.

Processing continues at 206 where the rewards systems processes transaction data, offer data, and cardholder data to identify messages that require transmission. Processing at 206 includes transmitting offer messages to messaging gateway(s) (such as gateways 120 of FIG. 1) for delivery to mobile devices associated with cardholders. For example, processing at 206 may include iteratively analyzing transaction data to identify transactions associated with active offers and with participating cardholders. The transaction data is then compared to the offer rules and cardholder status to determine if a reward message needs to be transmitted to a cardholder. In some embodiments, as will be described further below, a number of different messages may be transmitted for each offer, including status messages associated with transactions during the course of qualifying for a reward (e.g., such as a message that says “John, you only need to make one more purchase in the next two days to earn a $25 statement credit.”), and reward completion messages associated with a qualifying event (e.g., such as a message that says “John, congratulations, you just earned a $25 statement credit that should be reflected on your next statement.”).

Those skilled in the art will appreciate that a variety of other messages may also be triggered and transmitted by the rewards system of the present invention. For example, in some embodiments, discounts may be identified and applied to transactions pursuant to the present invention. As a specific example, a merchant discount may be established which specifies that cardholders making a purchase that exceeds $100 will receive a discount of 10% of the total transaction amount. Embodiments of the present invention allow such discounts to be communicated to the cardholder substantially in real time after the completion of the transaction (e.g., with a message telling the cardholder of the amount of the discount earned as a result of a qualified transaction).

Reference is now made to FIGS. 3A and 3B which are outward views of a user interface 300 which may be displayed to a cardholder wishing to opt in or register to participate in the rewards program of the present invention. As shown in FIG. 3A, a cardholder may register or opt in to participate in the rewards program by providing their name, payment device account number (e.g., a PAN in the case of a payment card), and the mobile number at which they wish to receive messages. The cardholder is also required to consent to participation terms (or “opt in” to the program terms and conditions). In some embodiments, a cardholder may opt in to a specific offer, or to an entire program (e.g., by consenting to participate in all offers in a program). The data captured by the user interface is transmitted to the rewards system 116 and is used to update the cardholder database 1000 (shown in FIG. 10, below). In some embodiments, the user interface shown in FIG. 3A is a mobile application downloaded by the user prior to registration. For example, the cardholder may be provided a link or icon which, when clicked, takes the cardholder to a download site so that the mobile application can be installed on their mobile device.

In some embodiments, the data provided by the cardholder via the interface of FIG. 3A is transmitted to an issuer (associated with a payment card held by the cardholder and identified by the PAN provided by the cardholder). The issuer may collate or aggregate the received data and create a batch file or other submission for transmission to the rewards system 116. In some embodiments, the data transmitted from an issuer to the rewards system may include the data collected from the cardholder (including the cardholder name, PAN, mobile number) as well as a date and time stamp. The data, once received by the reward system, may be used to update the cardholder database 1000 (discussed below in conjunction with FIG. 10) and a unique cardholder identifier may be assigned to each cardholder to allow the rewards system 116 to uniquely identify each participant.

As shown in FIG. 3B, a confirmation of registration or participation is displayed to the cardholder, providing the cardholder with information about how to “opt out” of participation in the rewards program. In some embodiments, other messaging or information about the rewards program and the rewards program rules may be displayed to the cardholder so the cardholder will know what to expect (and how to qualify) during the reward process.

In some embodiments, the user interfaces shown at FIG. 3 may be presented to a cardholder on a mobile phone, personal computer, or other device capable of accessing an Internet registration page. In some embodiments, the completion of registration may cause a message to be transmitted to the cardholder's mobile device providing the cardholder with information on how to opt out or stop receipt of messages.

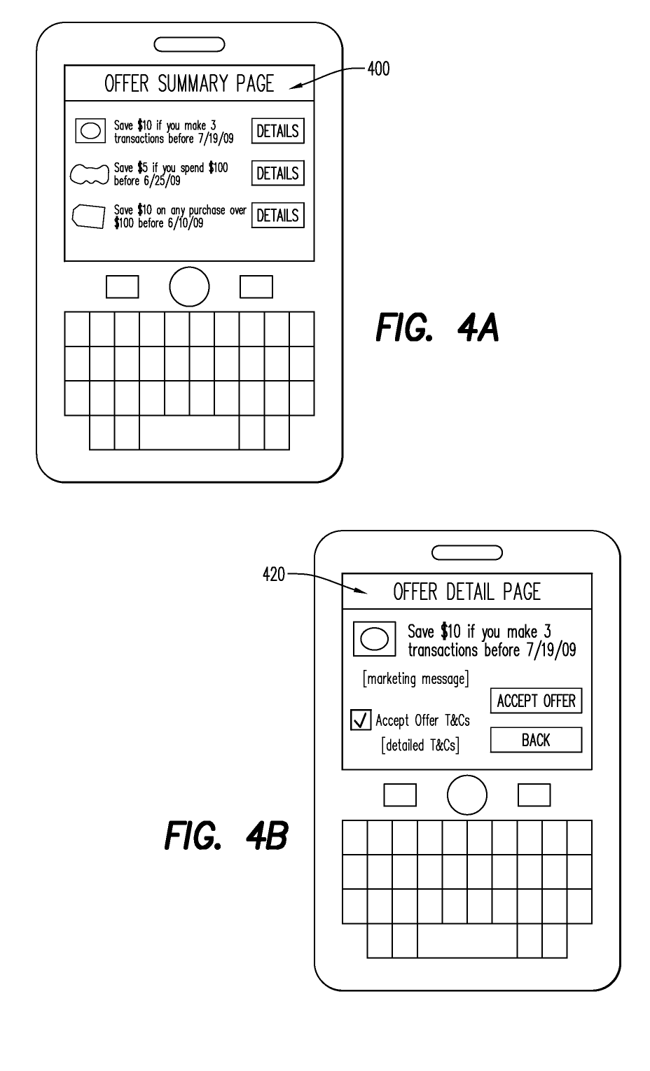

Reference is now made to FIGS. 4A and 4B, where another user interface is shown. The user interfaces of FIGS. 4A and 4B may be displayed on a user device associated with the cardholder, including a mobile phone, a personal computer, or the like. The user interface 400 of FIG. 4A is a representation of an offer summary page that may be presented to a cardholder who as registered to participate in a rewards program of the present invention. In particular, the offer summary page shows a list of reward programs that the cardholder is eligible to participate in. In the illustrative user interface, three sample offers are shown, each sponsored by a different merchant. The merchant logo or name is shown along with a brief explanation of the offer and the offer qualifying requirements (e.g., a merchant may offer a $10 discount if 3 transactions are made at the merchant before a certain date). Further details of each of the offers may be viewed by requesting further information (e.g., by clicking on a “details” link in the illustrative user interface).

FIG. 4B depicts an offer detail user interface 420. In the illustrative user interface 420, the cardholder has selected to view more details of the first of the three offers shown in FIG. 4A. The offer detail user interface 420 provides further information about the offer and qualifying requirements. The offer detail user interface 420 further includes an offer acceptance box and navigational icons. If a cardholder wishes to participate in the offer displayed in the offer detail user interface 420, the cardholder must first read and accept the offer terms and conditions and then accept the offer (e.g., by clicking on the box labeled “accept offer”). Once the cardholder accepts an offer, the offer details (or an offer identifier) are associated with the cardholder's record (e.g., in cardholder database 1000) so that transactions associated with the cardholder may be analyzed for reward process and messaging. In some embodiments, the registration process 300 would be structured so that the customer will accept the T&Cs for all offers available and not need to opt-in for each individual offer.

Pursuant to some embodiments, the user interfaces of FIG. 4 are displayed to a cardholder on their mobile phone. In some embodiments, cardholders may also view and accept offers on other devices (e.g., such as from a personal computer connected to the Internet). In some embodiments, physical representations of the user interfaces (such as direct mail pieces or statement inserts) may be mailed to the cardholder.

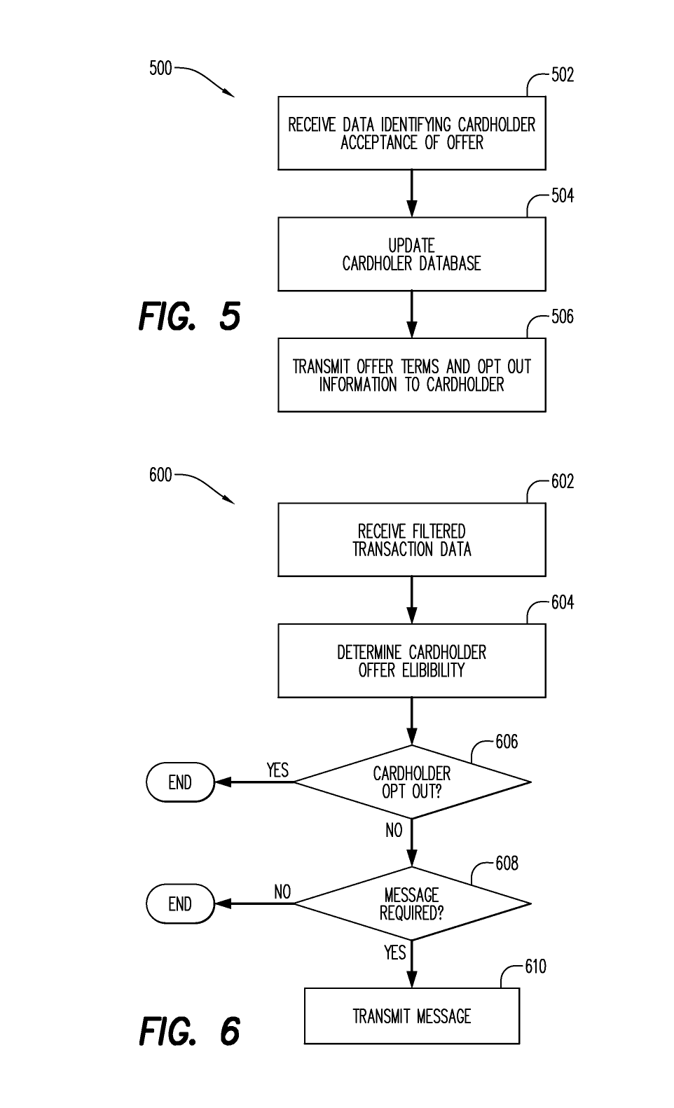

The offer selection process 500 is shown in FIG. 5. The offer selection process may be performed by a cardholder operating a mobile device in communication with a rewards system (such as the system 116 of FIG. 1). Process 500 begins at 502 where the rewards system receives data identifying cardholder acceptance of an offer. Processing at 502 begins with the cardholder viewing the offer details (such as over the interface shown in FIG. 4B) and accepting them (e.g., by clicking “Accept Offer”). The offer details may then be “clipped” or stored in the mobile application on the cardholder's mobile device (for future reference). The confirmation information (as well as data identifying the cardholder) are transmitted to the messaging server 120 (or to a mobile partner gateway, etc.). The messaging server 120 (or mobile partner systems) may batch confirmation information or transmit it in real time to the rewards system 116. The confirmation information stored may include, for example, the offer identifier, the cardholder identifier, the PAN, the mobile number, and a date or time stamp of the cardholder's opt in.

Processing continues at 504 where the rewards system 116 updates the cardholder database 1000 with the offer information and opt in confirmation.

Processing continues at 506 where the rewards system 116 identifies any confirmation message associated with the offer and causes the messaging server 120 to transmit the confirmation message to the cardholder's mobile device. In some embodiments, the rewards system 116 causes a single message to be transmitted for each selected offer. In some embodiments, each confirmation message transmitted includes information about how the cardholder can opt out of receiving any additional notifications for that particular offer. In some embodiments, cardholders may be given the ability to opt out of all communications. If a cardholder has previously opted out of receiving messages, the rewards server 116 does not transmit a confirmation message at 506.

As mentioned above, in some embodiments, the Registration process 300 would be structured so that the customer will accept the T&Cs for all offers available and not need to opt-in for each individual offer. In this case, the Offer Selection process 500 will be executed for all offers simultaneously or be included within the Registration process 300.

FIG. 6 shows a typical transaction flow involving a participating cardholder. That is, the process 600 involves a cardholder that has: (1) registered to participate in the rewards program (e.g., using the interface of FIG. 3), and (2) accepted (or “clipped”) an offer (e.g, using the flow of FIG. 5 and the interface of FIG. 4).

Process 600 begins at 602 where the rewards system 116 receives filtered transaction data involving a purchase made by a participating cardholder (e.g., at a point of sale system 104). For example, the filtered transaction data may include data that has had declined transactions removed, and that only includes transactions completed at participating merchants (e.g., as identified by MIDs stored in offer database 900).

Processing continues at 604 where the rewards system 116 processes the filtered transaction data to determine which transactions are associated with reward transactions and participating cardholders. For example, processing at 604 may include comparing the filtered transaction data with the cardholder data from database 1000 to identify those transactions that involve participating cardholders and the match offer eligibility rules. The transaction data may be compared to the stored cardholder PAN, and offer rules, including the transaction date, time and amounts.

For those transactions that are eligible for rewards (or that update a cardholder's reward progress or status), the cardholder database is updated to reflect the new status or eligibility. Processing continues at 606 where a determination is made whether the cardholder opted out of receiving messages for that particular offer (or for all offers). If so, no message is transmitted to the cardholder (although the cardholder's reward progress status is updated).

If the cardholder did not opt out of messaging, processing continues at 608 where a determination is made whether any messaging is required. For example, if a cardholder completed a transaction associated with an offer that requires 3 purchases in one month to qualify for a reward, and the merchant sponsoring the reward has specified that a message be generated for each of the 3 purchases, processing at 608 may result in a determination that a message is required.

Processing continues at 610 where a message is generated based on the offer status (in the example, the offer status is that the cardholder has completed the first of three required actions), and the message is transmitted to the cardholder. For example, processing at 610 may result in a message being sent to a messaging gateway 120 for delivery to the cardholder's mobile device. In some embodiments, the messaging can be delivered substantially in real time in response to the cardholder's completion of a purchase at a point of sale, providing the cardholder with near-immediate feedback on their rewards status. In some embodiments, the messaging may include a reminder of the additional steps required to complete the reward.

Processing continues again at 602 as additional transactions are analyzed. In some embodiments, the process 600 is performed in a batch process. In some embodiments, the process 600 is performed as filtered transaction data is received by the rewards system 116.

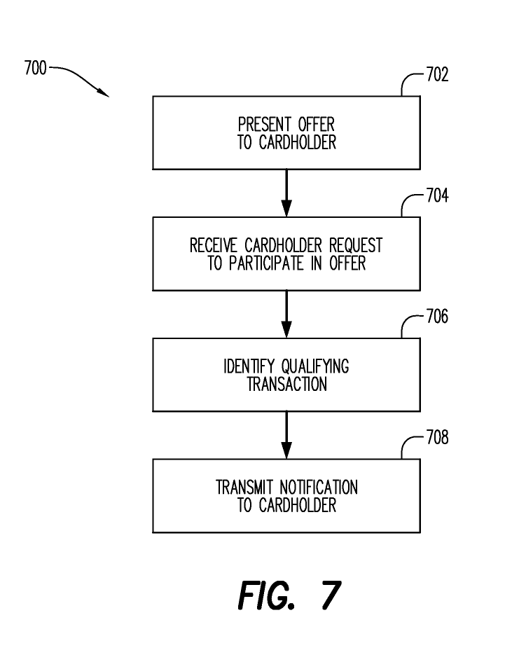

FIG. 7 is a flow diagram depicting a cardholder transaction 700, from the initial acceptance of a reward offer to receipt of a notice of a qualifying transaction. Processing begins at 702 where an offer is presented to a cardholder (e.g., on an interface of the cardholder's mobile device, such as the interface shown above in conjunction with FIG. 3).

Processing continues at 704 where the rewards system receives a cardholder request to participate in offer. The processing at 704 may also be referred to as offer “clipping” and may also result in details of the offer being stored on an application of the cardholder's mobile device. By requesting to participate in an offer, the cardholder's request is caused to be updated in the cardholder database 900 (where the offer identifier and opt in information are stored in association with the cardholder's information). In some embodiments, the offer clipping or selection (e.g., as shown in FIGS. 3 and 4) may include use of an XML-API interface between the reward system and a separate registration system (allowing cardholder's to enroll or join an offer instantaneously, or substantially in real-time). For example, a cardholder may view an offer on her mobile device while she is shopping in a store. She may join or accept the offer terms, and then enjoy the benefits of the offer while purchasing an item at the store.

In some embodiments, a cardholder may be automatically enrolled in all offers after registering for a program. For example, an issuer of cards may specify that all cardholders (or cardholders in a selected account number range) are participants in a specific reward program. The issuer may also specify that cardholders need not opt in to participate in specific offers—instead, cardholders in the program are automatically enrolled in offers pursuant to the program.

Processing continues at 706 where the cardholder uses their registered payment device to complete transactions and where the rewards system 116 identifies reward qualifying transactions. For example, processing at 706 includes the rewards system receiving filtered transaction data and matching transaction data to a cardholder and to an offer, and then comparing the transaction details (including the transaction date and amount) to the offer criteria to determine appropriate messaging and reward actions.

Processing continues at 708 where any messaging is transmitted to the cardholder. Pursuant to some embodiments, SMS messages are transmitted after a qualifying action at the POS (and after the transaction data has been processed at the rewards system 116). A qualifying action at the POS may vary based on each offer's terms and conditions. Examples of qualifying actions could be as follows: (i) Becoming eligible to receive statement rebate, (ii) Making any transaction at the merchant, or (iii). Reaching x % of cumulative spend or transaction threshold before earning rebate.

Pursuant to some embodiments, there is an option set by the cardholder and/or issuer to restrict SMS messaging when the consumer is traveling with his phone in other countries. The customer may receive the message immediately when he returns to his/her home country.

Pursuant to some embodiments, each SMS message has content including a message customized based on data from the cardholder database (e.g., such as the database shown in FIG. 10) and/or data from the offer database (e.g., such as the database shown in FIG. 9). For example, the following types of variable data may be included: the customer's name, offer details, qualifying actions required, etc. Several illustrative (but not limiting) examples of messages (prior to being merged with variable data, with the variable placeholders shown in brackets) include: (i) “Congratulations [Customer-first-name] ! You have earned a [rebate-value] statement rebate.”, (ii) “[Customer-first-name], you need to spend only [remaining-rebate-action] more within [period-remaining-value] [period-type] to earn a [rebate-value]”, (iii) “[Customer-first-name], you need to make [qualifying-actions-remaining] more transactions within [period-remaining-value] [period-type] to earn a [rebate-value] rebate.”

When populated with data from the offer database and cardholder database, these messages may render as follows: (i) “Congratulations Albert! You have earned a $25 statement rebate.”, (ii) “Albert, you need to spend only $45.50 within 7 days to earn a $50 rebate.”, and (iii) “Albert, you need to make 2 more transactions within 2 days to earn a $25 rebate.”

In some embodiments, the message will also (1) list the cumulative sum of statement credits and/or bonus points earned and (2) provide a new offer. Those skilled in the art will recognize, upon reading the present disclosure, that a wide variety of types of messages may be generated and presented to cardholders based on the completion of transactions, thereby providing cardholders with nearly instant alerts and feedback regarding their progress toward earning rewards and rebates.

Pursuant to some embodiments, each message (with variable data) may be generated by the rewards system 116 (as shown in FIG. 1) and transmitted to a gateway or other transmission system to deliver each message to a cardholder's mobile device. In some embodiments, some or all messages may be transmitted to other devices associated with the cardholder (e.g., a cardholder may indicate a preference to receive certain messages via electronic mail or other messaging mediums.)

FIG. 11 is an illustrative user interface which depicts the presentation of a rewards completion message on a user device 118 associated with a cardholder who has just completed a reward qualifying transaction. In some embodiments, the rewards completion message is displayed on a mobile phone associated with the cardholder, and is delivered to the cardholder substantially in real time after completion of the payment transaction that triggered the reward. In this manner, embodiments provide near instant feedback to consumers about rewards.

FIG. 8 is a block diagram of a rewards system 800 (such as the rewards system 116 of FIG. 1). Rewards system 800 may perform functions associated with the processing, analysis, and communication of rewards as described above. Rewards system 800 may comprise any suitable system, including but not limited to a computer server or network of computers. Rewards system 800 includes computer processor 810 operatively coupled to one or more communication devices 820, data storage device 830, one or more input devices 840 and one or more output devices 850.

Communication device(s) 820 may facilitate communication with one or more networks and/or external devices. For example, the communications device(s) 820 may allow the rewards system 800 to receive transaction information from the rewards data source 114, receive cardholder registration information from issuers 112, receive data from the messaging gateway 120, and transmit information to and from each of those devices. In some embodiments, one or more APIs are provided to facilitate communication between devices and the rewards system.

Input device(s) 840 may comprise, for example, a keyboard, a keypad, a mouse or other pointing device, a microphone, knob or a switch, an infra-red (IR) port, a docking station, and/or a touch screen. Input device(s) 840 may be used, for example, to manipulate user interfaces presented by output device(s) 850, and may be used by administrators or other system operators to update and maintain the rewards system 800.

Output device(s) 850 may comprise, for example, a display (e.g., a computer monitor), a speaker, and/or a printer. These output devices may be used, for example, to generate reports and/or export information to merchants.

Output device(s) 850 may also include consumer-facing channels. Channels include, but are not limited to mobile WAP sites, downloadable mobile applications, an online website, a direct mail piece, or IVR. These output devices may be used, for example, to display offer content to consumers (such as User Interface 400). In some embodiments, one or more APIs are provided as a mechanism/means to communicate between the processor 810 and the consumer-facing output devices 850. Other embodiments could include a batch process for manual file transfers.

Data storage device 830 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Data storage device 830 stores instructions adapted to be executed by processor 810, and may also store (or have access to) databases, including the offer database 900 (described below in conjunction with FIG. 9) and a cardholder database 1000 (described below in conjunction with FIG. 10). The program applications may comprise a set of instructions, and may be executed by processor 810 to cause system 800 to operate as described herein. The program applications comprise any type of executable instructions, including but not limited to a desktop application, a database procedure, a database application, and a server application.

Data used to populate messages, as well as data used to define offers and offer conditions may be stored in one or more offer databases such as the offer database of FIG. 9. FIG. 9 depicts a data table 900 for storing data defining one or more offers that are to be administered by the rewards system of the present invention and for which cardholders may opt in to participate. The data table 900 includes a number of database records, each record having a number of fields defining data that may be used to identify, track and administer offers pursuant to the present invention. Several illustrative records are shown, and several illustrative fields are shown—those skilled in the art will appreciate that in use, a large number of records may be stored and administered using the present invention. Standard database management and design techniques may be used to structure, manage and administer the data table 900 (as well as other databases described herein), and the depicted tables are for illustrative purposes only.

As shown, data table 900 includes a number of fields, including an offer identifier 902, one or more corresponding merchant identifiers (“MIDs”) 904, a rebate amount 906, one or more eligibility rules 908 and one or more messages 910. The offer identifier 902 may be an alphanumeric identifier that uniquely identifies each offer in the database. The offer identifier 902 may be automatically assigned by the rewards system when an offer is created, or it may be assigned in other ways. Each offer identified by an offer identifier 902 is associated with one or more MID's 904 that specify the merchants or merchant locations participating in the offer. The rebate amount 906 may specify the dollar amount or other value associated with the offer (and is the amount or value that a cardholder who completes an offer will receive). The eligibility rules 908 may include a number of data elements that specify the actions that a cardholder must perform in order to receive the rebate amount 906. As described above, a number of different types of eligibility rules may be specified.

Each offer may also include one or more messages 910 which are transmitted to a cardholder as the cardholder takes steps to qualify for a rebate amount 906. For example, messages 910 may include a sequence of messages that are transmitted to participating cardholders as they take steps to qualify for a rebate. As a simple illustrative example, an offer which requires three purchase transactions to be completed within a period of time may include 3 messages—the first sent after the first purchase transaction is completed, the second after the second transaction, and the third after the qualifying transaction. Each message may include variable data to personalize the message to the cardholder and to their particular transaction sequence. Those skilled in the art will appreciate that other types of data and fields may also be included.

The data from the database 900 may be used, for example, to generate cardholder status information or savings statements which may be displayed to the cardholder on user device 118, or printed and delivered via mail, thereby providing the cardholder with a single view of the status of all rewards programs the cardholder is participating in.

Data used to identify cardholders participating in rewards programs pursuant to the present invention, as well as the offers a cardholder has opted to participate in, as well as the cardholder's progress in qualifying for different offers, may be stored in one or more cardholder databases such as the database 1000 of FIG. 10.

As shown, database 1000 includes a number of data fields, including a cardholder identifier 1002, a primary account number (“PAN”) 1004, one or more phone numbers 1006, one or more active offer(s) 1008, and opt out data 1010.

Cardholder identifier 1002 may be an alphanumeric identifier that is assigned to each cardholder to uniquely identify them. The PAN 1004 is the account number associated with a payment device (such as a credit card, debit card, prepaid card, bank account, or the like) that the cardholder has registered with the rewards system for use in qualifying for a particular offer. In some embodiments, a cardholder may register more than one payment device. The phone number(s) 1006 may be mobile telephone numbers associated with one or more mobile devices owned or controlled by the cardholder. The phone number provided by a cardholder is, preferably, associated with a mobile device that the cardholder wishes to receive rewards messages and alerts on. Active offer(s) 1008 includes one or more offer identifiers (such as the offer identifiers 902 of offer database 900 described above) that the cardholder has registered for. For example, the active offer(s) 1008 may be the offers selected by the cardholder during a process such as the process described in conjunction with FIG. 4, above. In some embodiments, a cardholder record may include information identifying a number of active offers (or offers that the cardholder has elected to participate in, and for which the cardholder has not yet qualified to receive a reward amount).

Opt out data 1010 may include information (including, in some embodiments, a time stamp, an IP address, and other information) indicating that the cardholder has opted out of any messaging associated with a particular offer. For example, a cardholder may wish to not receive messaging related to a particular offer or related to the cardholder's progress toward qualifying for a reward or rebate. The use of opt out data 1010 allows the rewards system to prevent messages from being sent on that particular offer. In some embodiments, if no data is included in opt out data 1010 field, then messages will be sent to the cardholder regarding a particular offer.

Some of the data in database 1000 may be entered during, for example, a cardholder registration process such as the registration process described above in conjunction with FIG. 3.

Although the present invention has been described with respect to example embodiments thereof, those skilled in the art will appreciate that various substitutions or modifications may be made without departing from the spirit and scope of the present invention. For example, the processes have been described with a “payment association” or “authorization systems” such as the MasterCard payment brand and their BankNet® authorization systems. Those skilled in the art will appreciate that other entities may also operate some or all of the process steps (including, for example, closed payment networks, regional or local payment networks, or the like). Further, a “payment device” or “credit card” has been discussed. Those skilled in the art will appreciate that embodiments may be used in conjunction with other payment devices such as stored value cards, gift cards, ACH transactions, checks, debit cards, or the like.

Further, each of the embodiments disclosed herein may be used in conjunction with each other. For example, a transaction may include aspects of reward messaging, discounts and points redemption or some combination thereof. Further, pursuant to some embodiments, individual accounts or account ranges may have different levels of rebates, discounts, types of reward messages, and point redemption rules.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A rewards system, comprising:
a transaction processing system, receiving a transaction authorization request message generated from a point of interaction, the transaction authorization request message including a purchase amount, and a customer account identifier, the transaction processing system generating an authorization response message for transmission to the point of interaction; and
a messaging system, in communication with the transaction processing system, generating a rewards message for transmission to a mobile device associated with the customer account identifier, the rewards message including details of a status associated with a reward transaction.

2. The rewards system of claim 1, wherein said rewards message is transmitted substantially at the same time as said authorization response.

3. The rewards system of claim 1, wherein said messaging system transmits said rewards message in response to said authorization response.

4. The rewards system of claim 1, wherein said rewards message is transmitted as at least one of an SMS message, an electronic mail message, an XML message, and a push notification within a mobile application.

5. The rewards system of claim 1, wherein said rewards message is one of a reward completion message and a reward progress message.

6. The rewards system of claim 5, wherein said reward completion message includes information identifying a reward amount earned based on completion of a transaction associated with said transaction authorization request.

7. The rewards system of claim 6, further comprising:
causing said reward amount to be credited to said customer account identifier.

8. The rewards system of claim 5, wherein said reward progress message includes information identifying a reward status, and information identifying additional qualifying steps to complete said reward.

9. The rewards system of claim 1, wherein said messaging system is at least one of an SMS messaging gateway, an e-mail messaging gateway, and a mobile provider system.

10. The rewards system of claim 1, wherein said rewards message pertains to at least one of: statement rebates, bonus points, coupons, and discounts.

11. A method, comprising:
providing a plurality of reward offers to be presented to a cardholder operating a mobile device each of said plurality of reward offers including information identifying a merchant, at least one offer qualifying condition, and a reward amount;
receiving a request generated from said cardholder to participate in at least a selected one of said reward offers;
associating an offer identifier associated with said at least a selected one of said reward offers with information identifying said cardholder, including a cardholder phone number and a cardholder payment account number; and
providing an offer enrollment message to be transmitted to said mobile device.

12. The method of claim 11, wherein said presenting a plurality of reward offers is performed through at least one of: a mobile application, a Website, a WAP site, an IVR system, an electronic mail message, and a direct mail piece.

13. The method of claim 11, wherein said transmitting an offer enrollment message is performed using at least one of: a mobile application, a Website, a WAP site, an IVR system, an electronic mail message, and a direct mail piece.

14. The method of claim 11, further comprising:
receiving transaction data associated with a transaction involving said cardholder payment account number;
comparing said transaction data with offer criteria associated with said offer identifier;
determining that said transaction data meets said offer criteria; and
updating a status of a reward eligibility of said cardholder for said offer identifier.

15. The method of claim 14, further comprising:
determining that said cardholder has opted out of receiving messages.

16. The method of claim 14, further comprising:
determining that said cardholder has not opted out of receiving messages; and
transmitting a reward status message to a mobile device associated with said cardholder.

17. The method of claim 11, further comprising:
receiving a request from said cardholder to download a reward offer application prior to presenting said plurality of reward offers.

18. The method of claim 17, further comprising:
receiving cardholder registration data after said request to download, said cardholder registration data including a cardholder name, at least a first cardholder payment account number, and a telephone number associated with said mobile device.

19. The method of claim 14, further comprising:
processing said transaction data to remove transactions not associated with a merchant involved in a reward program.

20. The method of claim 11, wherein said receiving a request to participate includes storing information associated with said selected one of said reward offers in at least one of: (i) an application on said mobile device, and (ii) a remote storage location.

21. A computer-readable medium storing instructions adapted to be executed by a processor to perform a method, the method comprising:
providing a plurality of reward offers to be presented to a cardholder operating a mobile device, each of said plurality of reward offers including information identifying a merchant, at least one offer qualifying condition, and a reward amount;
receiving a request generated from said cardholder to participate in at least a selected one of said reward offers;
associating an offer identifier associated with said at least a selected one of said reward offers with information identifying said cardholder, including a cardholder phone number and a cardholder payment account number; and
providing an offer enrollment message to be transmitted to said mobile device.

22. The computer-readable medium storing instructions of claim 21, wherein said presenting a plurality of reward offers is performed through at least one of: a mobile application, a Website, a WAP site, an IVR system, an electronic mail message, and a direct mail piece.

23. The computer-readable medium storing instructions of claim 21, wherein said transmitting an offer enrollment message is performed using at least one of: a mobile application, a Website, a WAP site, an IVR system, an electronic mail message, and a direct mail piece.

24. A medium according to claim 21, the method further comprising:
receiving transaction data associated with a transaction involving said cardholder payment account number;
comparing said transaction data with offer criteria associated with said offer identifier;
determining that said transaction data meets said offer criteria; and
updating a status of a reward eligibility of said cardholder for said offer identifier.
